(19) United States
(12) Patent Application Publication
(10) Pub. No.: US 2008/0065253 A1
(43) Pub. Date: Mar. 13, 2008

(54) Method for Controlling and Planning the Order of Production

(75) Inventors: Martin Daferner, Sindelfingen (DE); Reiner Supper, Sindelfingen (DE)

Correspondence Address: Davidson Davidson & Kappel, 485 Seventh Avenue, 14th floor, New York, NY, 10018, US

(73) Assignee: DAIMLERCHRYSLER, STUTTGART (DE)

(21) Appl. No.: 10/552,355

(22) PCT Filed: Feb. 21, 2004
(86) PCT No.: PCT/EP04/01732

§ 371 Date: Feb. 13, 2007

(30) Foreign Application Priority Data
Sep. 17, 2003 (GB) 0321768.4

(51) Int. Cl. G06F 19/00

(52) U.S. Cl. 700/116

(57) ABSTRACT

A method for automatically controlling a production process for the mass production of order specific products with a first and a second partial process and an exit buffer (500.3) which comprises a fixed maximum number of spaces for production objects (20.2, 20.3,). A sequence (60) for the order of products, which are produced in the production process, is produced. In the first partial process, objects are produced according to the order sequence (70). A selection process occurs, wherein a produced object from the produced object sequence and an application from the application sequence, corresponding to each other, are selected. If the first application of the application sequence does not match a production object in the exit buffer or corresponds to a first produced object from the sequence of produced objects and if sufficient free space is available in the exit buffer, the first application and the produced object matching the sequence of produced objects are selected. All production objects from the sequence of produced objects (70) are adjusted in the exit buffer (500.3) before the selected production object. Preferably, the number of available spaces is determined by the simulations.

The present invention is directed to a method for automatically controlling a production process for the series production of order-specific products. The order-specific products are motor vehicles, for example, which are manufactured on the basis of customer orders that differ from one another in many features. The production process includes a first and a second subprocess, such as the body-in-white production as a first subprocess and the “surface finishing” subprocess, including the painting lines, as a second subprocess, or the surface finishing as a first and the interior assembly as a second process.

A method according to the definition of the species set forth in claim 1 is known from the German Patent Application DE 199 27 563 A1. It discusses separating the production-object sequence from the order sequence. In a first subprocess, which it refers to as production step, a sequence of production objects is manufactured according to the order sequence. Each production object, called product in this case, is produced on the basis of an order from the order sequence. After cycling through the first subprocess, each production object is temporarily assigned the same or a different order. In this way, a production object and an order are selected for the second subprocess. A work order is generated for the second subprocess to process the selected production object in accordance with the selected order, and is processed when the production object cycles through the second subprocess.

When applying the method as described in DE 199 27 563 A1, the situation can often arise that, instead of the first order of the order sequence, a later order is assigned to the first production object of the production-order sequence. One reason for this is the manufacturing of the production object produced on the basis of the first order was delayed in the first subprocess, causing it to be overtaken by another production object. As a result, the processing of the first order in the second subprocess begins with a delay, thereby entailing the risk of the product for the first order being finished behind schedule.

U.S. Pat. No. 5,229,948 describes a method for automatically optimizing the system parameters of a serial manufacturing process (“manufacturing system”), in order to meet specified requirements relating, for instance, to the number of manufactured products. The system parameters include the cycle time, the capacities of the buffers used for production objects, process resources, and maximum repair times. The production objects cycle through buffers, for example between subprocesses, which each have parallel production lines. A stochastic model is presented. By optimizing the same, one obtains an assignment of the system parameters sought. The method described in U.S. Pat. No. 5,229,948 can be applied to the production of substantially identical products, i.e., not to products that are to be manufactured in accordance with order-specific instructions.

The German Patent DE 199 02 056 C1 describes a method for establishing a sequence among orders for motor vehicles, individual orders being combined to form an order sequence. To this end, technical features of the particular product specified by an order are weighted, the received orders are evaluated on the basis of the features and their weightings, and an overall assessment of each possible order sequence is generated. The method does not stipulate the order in which production objects are to be produced for the products specified by the order sequence.

The use of a buffer for production objects is known from the German Patent Application DE 198 15 619 A1. This buffer is used for rearranging the sequence of the production objects for the subsequent production process.

The object of the present invention is to devise a method in accordance with the definition of the species set forth in claim 1, which will result in fewer orders being delivered to the second subprocess behind schedule.

The objective is achieved by a method as set forth in claim 1 and by a device as set forth in claim 25. Advantageous embodiments are defined by the dependent claims.

A sequence of orders existing in electronic form is generated for products manufactured in the production process. In the first subprocess, a sequence of production objects is manufactured according to the order sequence. A selection process is carried out whereby a production object from the production-object sequence and an order from the order sequence that match each other are selected. The selection process and product manufacturing are repeated until a product has been manufactured for every order of the order sequence.

In accordance with the present invention, a sorting buffer having spaces for production objects is provided. The sorting buffer is located between the first and the second subprocess and preferably allows a random access to each production object placed therein. If the first production object of the production-object sequence does not match the first order of the order sequence, a production object from the production-object sequence matching the order is moved up to the first position of the production-object sequence. This is accomplished by temporarily placing all production objects of the production-object sequence located upstream of the matching production object in the sorting buffer, until the matching production object becomes the first production object. The production object moved up to the first position and the first order from the order sequence are selected, and the selected production object is processed in the second subprocess in accordance with the selected order.

The present invention makes it possible for the first order to be delivered to the second subprocess without any delay, more often than does the method according to German Patent Application DE 199 27 563 A1. The use of the sorting buffer is particularly beneficial when the structuring of the production process and/or the configuration of the available facilities in a production facility prevent a production object of the production-object sequence from overtaking another production object.

In the first subprocess, each production object is manufactured on the basis of an order from the order sequence. This production object occupies a specific position in the production-object sequence. This position may deviate from the position of the particular order on whose basis the production object was manufactured. The production object may precede or follow this order. In such a case, it may be necessary to provide interim storage for the production object. However, the present invention does not require that the sorting buffer be sized to be large enough to intermediately store all of the production objects located upstream of the production object that was produced on the basis of the first order. Instead, the first production object matching the first order is selected, and this matching production object may be a different one from that which was manufactured on the basis of the first order.

The production process is preferably organized in such a way that the production objects differ from one another in only relatively few features, each having a few characteristics. The method according to the present invention may be used to particular advantage in such a case. This is because it makes it possible to utilize this relatively low variance to achieve its objective and, to this end, to use a sorting buffer having only relatively few available spaces. Since the production objects only have a relatively slight variance, it is quite often the case that one of the first production objects matches the first order, and that, on average, only relatively few production objects are placed in the sorting buffer.

By suitably designing the test for determining whether a production object and an order match each other, it is possible to control the production process in such a way that specified requirements are met and predefined boundary conditions are satisfied. For instance, if the sorting buffer has a relatively small number of available spaces, the test is preferably performed in such a way that a relatively large number of production objects matches an order. This is achieved, for example, by considering only a small number of product features in the test. On average, only relatively few production objects will then be placed in the sorting buffer, since they will have been considered to be non-matching. The second subprocess must then be devised to be flexible enough to process a selected production object according to a selected order, even when the production object matches the order in only relatively few features.

On the other hand, if the second subprocess is optimized for a high throughput and is not very flexible, the test is preferably performed in a way that requires many features of the production object to match the corresponding product features, in order for the production object and the order to be considered a match. It is expedient for a sorting buffer having many spaces to be provided.

The constraint is taken into consideration, whereby it is not possible for any given number of production objects to be placed in the sorting buffer. Rather, the sorting buffer has a fixed maximum number of available spaces for production objects. The sorting buffer is constituted, for example, of a high-bay rack storage or of storage spaces in an open area. Therefore, prior to selecting a matching production object, it is checked whether there is a sufficient amount of space in the sorting buffer for all of the production objects upstream of the matching production object. In this context, it is checked whether free spaces are available in the sorting buffer for all of the production objects in the production-object sequence upstream of a production object matching the first order. Only in the case that a sufficient number of free spaces is available, is the matching production object moved up to the first position and selected together with the order.

One preferred specific embodiment provides for the production object to be removed from the sorting buffer again, if this is possible. In this way, a space is once again made available. For that reason, it is preferably the production objects in the sorting buffer that are first compared to the first order of the order sequence, and, only then, the production objects of the production-object sequence. In a selection process as set forth in claim 6, if the first order of the order sequence matches a production object in the sorting buffer, the first order and the production object are selected. The production object is then removed from the sorting buffer.

In accordance with the embodiment of claim 7, if an insufficient number of free spaces is available or if no production object matching the first order is found, then the order is not selected, but deferred. An initially empty electronic buffer memory for orders is created for deferring orders. If the matching production object cannot be moved up to the first position, the first order is placed in this buffer memory.

Orders that were returned to the buffer memory are able to be selected in subsequent selection processes, when, for instance, moving up a matching production object does not require moving up as many non-matching production objects, or when more free spaces are available in the sorting buffer. This makes it possible for the orders to still be processed, even if with a delay, which is preferable to having to cancel them.

In accordance with one preferred specific embodiment, priority is given to searching for a matching production object for an order that had been deferred by placing it in the buffer memory. This has the effect that orders are deferred for only the shortest time needed and that they remain in the buffer memory for only the fewest possible selection processes. As set forth in claim 8, it is first checked whether an order in the buffer memory matches a production object in the sorting buffer. If this is the case, the order and the production object are selected. The order is removed from the buffer memory, and the production object is removed from the sorting buffer. If no production object in the sorting buffer matches an order in the buffer memory, an order in the buffer memory and a matching production object in the production-object sequence are selected. If the matching production object is not the first of the sequence, it is moved up to the first position with the aid of the sorting buffer. The order is removed from the buffer memory. The selection process and move-up operation are only carried out if a sufficient number of free spaces is still available in the sorting buffer. Otherwise, the order in the buffer memory is not selected.

When a plurality of orders resides in the buffer memory, several embodiments of the specific embodiment according to claim 8 stipulate whether—and if so, how—one of these is selected. If the sorting buffer has a maximum number of available spaces, an order matching a production object of the production-object sequence that may be moved up to the first position, is sought. If a plurality of such orders resides in the buffer memory, the one having the longest dwell time will be selected, for example, or that order whose selection will entail the fewest processes for placing the same in the sorting buffer. In accordance with the embodiment as recited in claim 9, a maximum number of selection processes is specified, for example on the basis of a requirement for the maximum delay allowed to complete an order. An order in the buffer memory is selected when the number of selection processes during which this order has remained in the buffer memory, reaches or exceeds the specified maximum number. In this case, the order is selected, even if another order in the buffer memory matches a production object in the sorting buffer or entails fewer processes for placing the same in the sorting buffer.

The specific embodiments of the method described so far provide for an order to be placed in the buffer memory only when the number of free spaces available in the sorting buffer does not suffice for a matching production object of the production-object sequence to be moved up to the first position. Otherwise, the first order and a matching production object are selected. The embodiment according to claim 10 takes into consideration that it is more expensive and time-consuming to place a production object in the sorting buffer than it is to place an order in the electronic buffer memory. For that reason, in accordance with claim 10, the first order of the order sequence is already placed in the buffer memory when the first order neither matches a production object in the sorting buffer nor the first production object of the production-object sequence. The second order is then compared to the production objects in the sorting buffer and to the first production object of the production-object sequence, and so forth.

It is ensured that an order does not remain in the buffer memory for an excessive length of time. Therefore, in a selection process, the orders in the buffer memory are first compared to the production objects in the sorting buffer and in the production-object sequence. In addition, for each order in the buffer memory, the number of selection processes during which the order has already remained in the buffer memory, is counted. Preferably, a matching production object is first sought for the order having the highest dwell number. If the dwell number of an order in the buffer memory has reached a predefined maximum number, this order and a matching production object are selected in any event, provided a matching production object is available in the sorting buffer or is able to be moved up to the first position in the production-object sequence.

One embodiment of the method according to the present invention provides for using simulations in advance, to determine the sizing of the sorting buffer. As set forth in claim 17, various possible values are predefined for the maximum number of available spaces in the sorting buffer for production objects. In the case that the effects a sorting buffer has to begin with are to be additionally determined by simulations, the value 0 is predefined as one of the possible values for the simulations. In the simulations, a determination is made for each possible value as to what effects a sorting buffer having such a value as a maximum number of available spaces would have on a reference sequence of orders and production objects.

In a first phase, a reference sequence of reference orders existing in electronic form is generated for reference products produced in the production process. In addition, a sequence of reference production objects is produced in the first phase in accordance with the reference order sequence in the first subprocess. The order in which the production objects exit the first subprocess is logged. In this way, a copy of the reference production-object sequence is generated. Those features of reference orders and reference production objects, which are used for selecting reference orders and reference production objects for the second subprocess, are also logged. The features are logged because the selection processes for the second subprocess are carried out in the simulation and with the aid of a simulated sorting buffer, and the logged features are used for these simulations.

There is not yet a need for a sorting buffer to be available in the first phase. There is likewise no need for the actual sequence of the selection processes of reference orders and reference production objects to be logged in the first phase, since this actual sequence will not be used for the simulation.

The simulations are performed in the second phase in order to determine the number of available spaces in the sorting buffer. An electronic copy of the logged reference production-object sequence is generated. In addition, a model of the sorting buffer is created. A simulation is performed for each one of the possible values. In the process, the maximum number of available spaces of the sorting-buffer model is set to the particular value. A simulation of all selection processes for the second subprocess is performed using the reference-order sequence, the copy, the sorting-buffer model and the buffer memory. In those cases where the first reference order of the reference-order sequence does not match any reference-production object in the sorting-buffer model, it is checked in the simulation whether free spaces are available in the sorting-buffer model for all copies of reference-production objects located in the copy of the reference production-object sequence upstream of a reference-production-object copy matching the first reference order. If a sufficient number of free spaces is available, the first reference order and the reference production-object copy matching the reference order are selected. All reference production-object copies that are located upstream of the selected reference production-object copy in the copy of the reference production-object sequence are placed in the model of the sorting buffer. In the simulation, a reference production-object copy may be placed in the model when and only when the model still has a free space.

One of the possible values is selected as a function of the results of the simulations. A sorting buffer having the selected value as the maximum number of available spaces is selected as the real sorting buffer for the selection processes of the actual order sequence.

Simulations are substantially less expensive and can be performed more rapidly than tests using real production objects. Since simulations are performed in advance, a properly sized sorting buffer is used. One avoids using too small of a buffer, which could lead to too many orders being deferred. On the other hand, a sorting buffer that is larger than necessary often consumes too much capital and takes up too much space. The method as recited in claim 17 describes an objective and reproducible procedure for sizing the sorting buffer.

The simulations are performed on the basis of the sequences logged in the first phase. These logs are often available anyway. The simulations do not require a model of the production process or of the first subprocess. It is a time-consuming and error-prone process to prepare such a model, so that it is advantageous that no such model is required.

The effects that a sorting buffer having a predetermined maximum number of available spaces has on the faithfulness-to-position are preferably determined by the simulations. When an order is selected after having been moved up to the first position in the selection sequence, it is then faithful-to-position upon reaching the second subprocess. If it becomes necessary to defer the order and place it in the buffer memory, it reaches the second subprocess too late, because the first production object of the production-object sequence does not match, so that it is not possible to move up a matching production object to the first position. When an order is selected, even though it is not yet the first order of the order sequence, it then reaches the second subprocess too early. This can only happen when another order had been deferred and placed in the buffer memory. For that reason, the degree of faithfulness-to-position, i.e., the proportion of orders in the total number of orders of the order sequence that are faithful-to-position, is used as a quantifiable and measurable measure of the effects of a sorting buffer having a specified maximum number of available spaces. It is self-evident that the degree of faithfulness-to-position increases, the greater the maximum number of available spaces in the sorting buffer. This is because the more free spaces the sorting buffer has, the fewer the number of orders that need to be deferred due to a lack of free spaces prevent a matching production object from being moved up to the first position. Therefore, the degree of faithfulness-to-position for the reference sequence is preferably determined in the simulations.

A faithfulness-to-position function is determined in accordance with one embodiment. For each possible number of available spaces, this function indicates the degree of faithfulness-to-position obtained. The function rises monotonically, since the more spaces are available, the greater the faithfulness-to-position is achieved. It is possible to determine when increasing the maximum number of available spaces still has a significant effect on the degree of faithfulness-to-position, and when it does not.

An exemplary embodiment of the method according to the present invention is described in greater detail with reference to the attached drawing. In the drawing, the figures show:

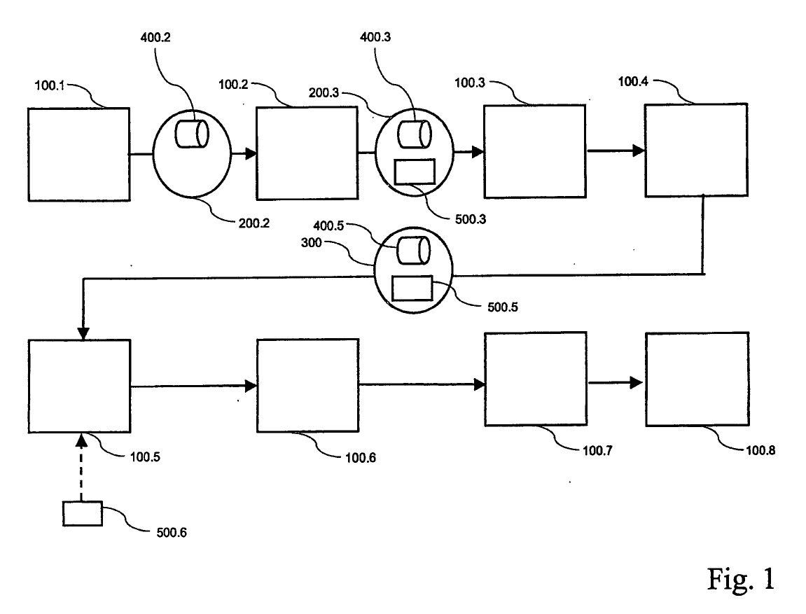

FIG. 1 the sequence of eight stations of a production process for manufacturing motor vehicles;

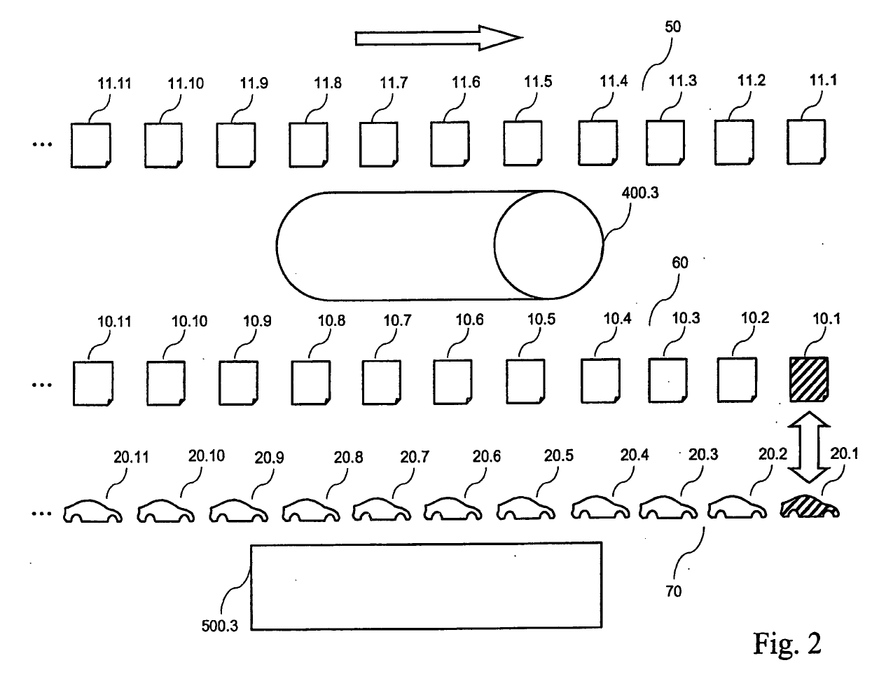

FIG. 2 the production objects and orders in the exemplary embodiment, subsequent to the first selection process;

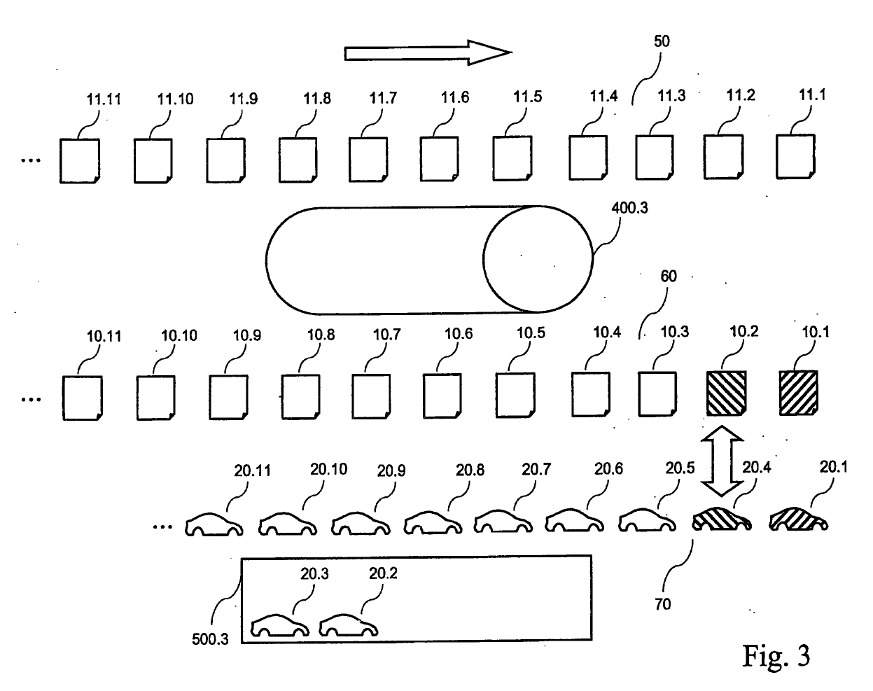

FIG. 3 the production objects and orders in the exemplary embodiment, subsequent to the second selection process;

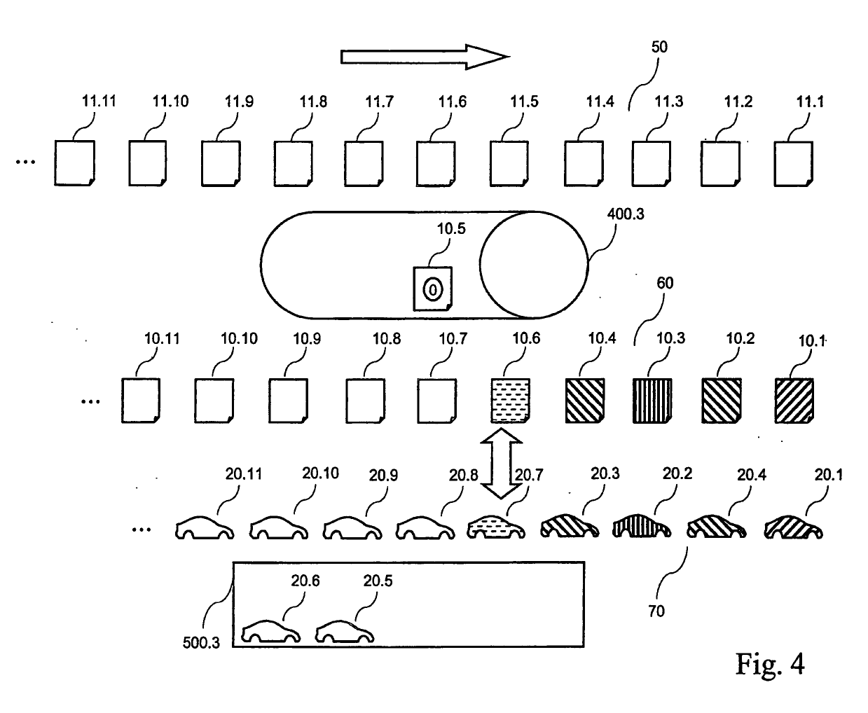

FIG. 4 the production objects and orders in the exemplary embodiment, subsequent to the fifth selection process;

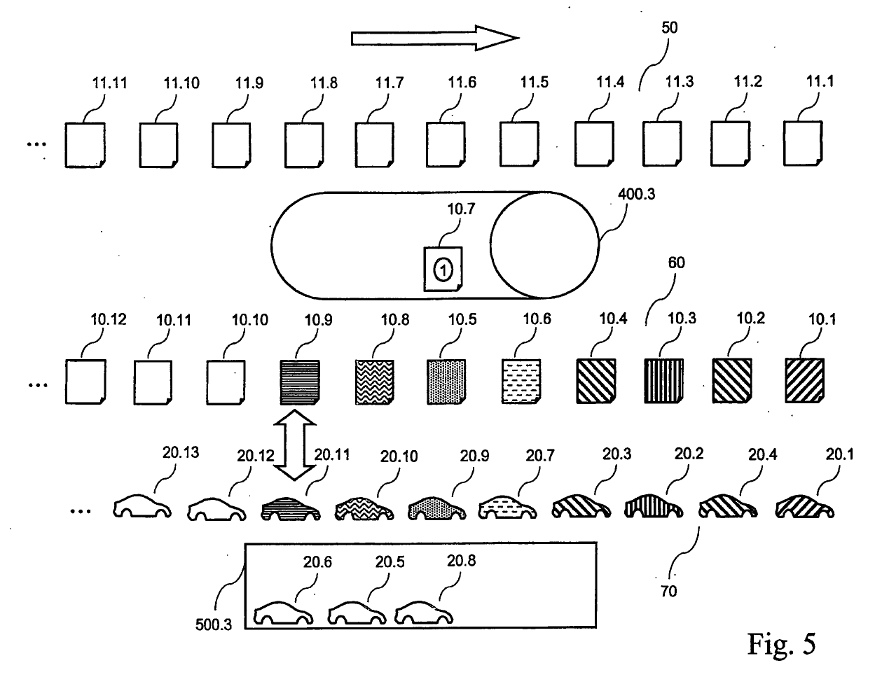

FIG. 5 the production objects and orders in the exemplary embodiment, subsequent to the eighth selection process;

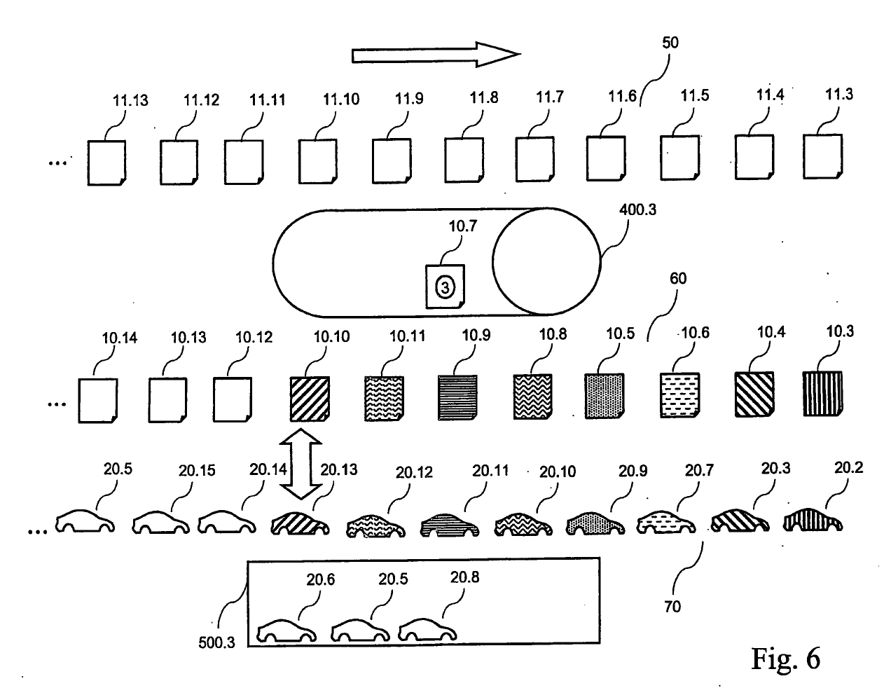

FIG. 6 the production objects and orders in the exemplary embodiment, subsequent to the tenth selection process;

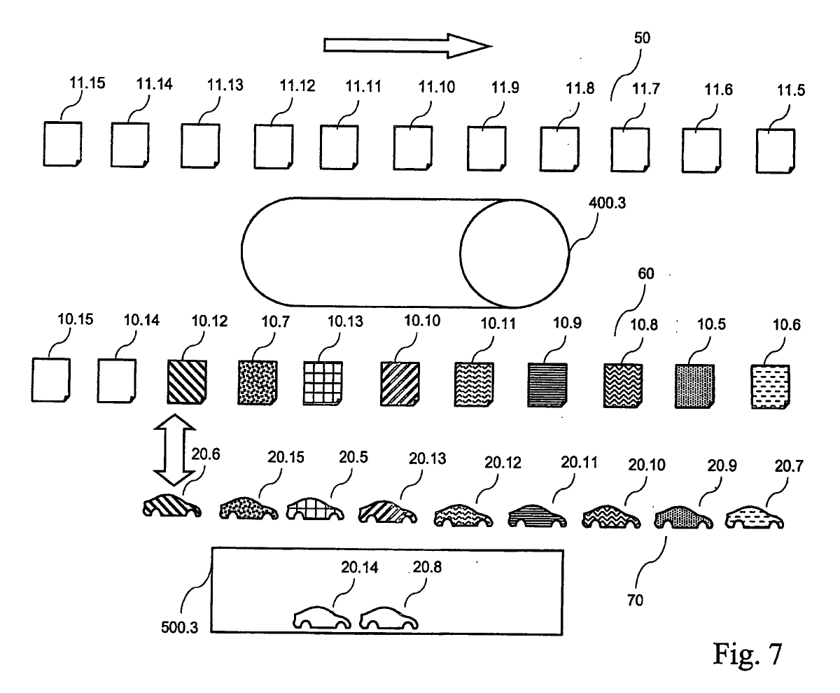

FIG. 7 the production objects and orders in the exemplary embodiment, subsequent to the thirteenth selection process;

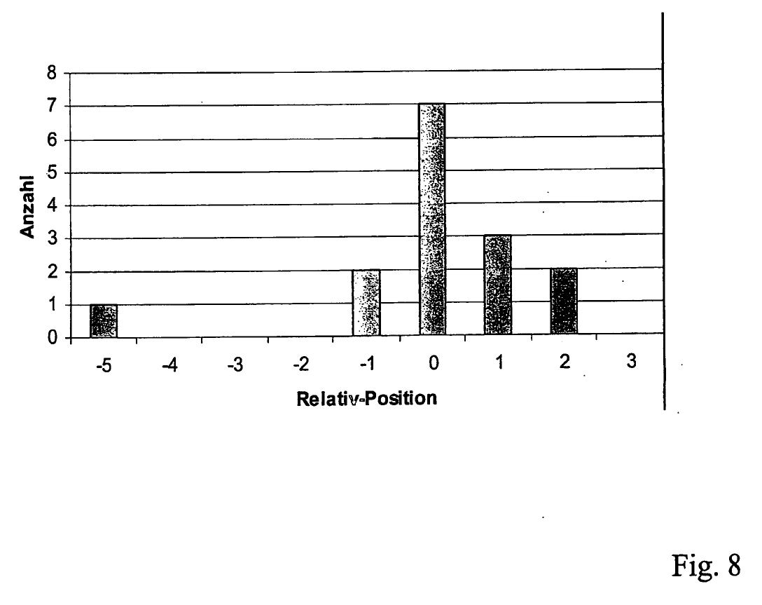

FIG. 8 a histogram illustrating the distribution of the relative positions of the orders;

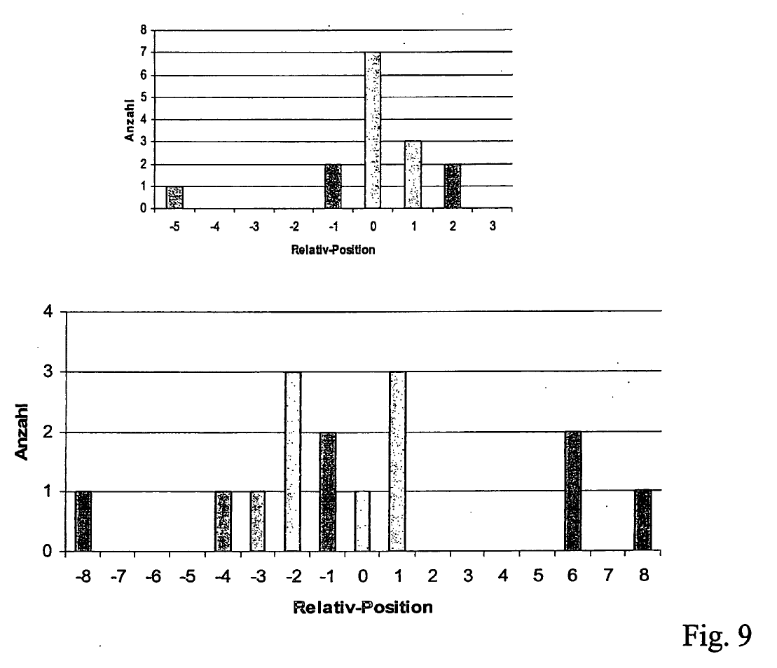

FIG. 9 a histogram illustrating the distribution of the relative positions of the orders in the case that no sorting buffer is used, and the histogram from FIG. 8;

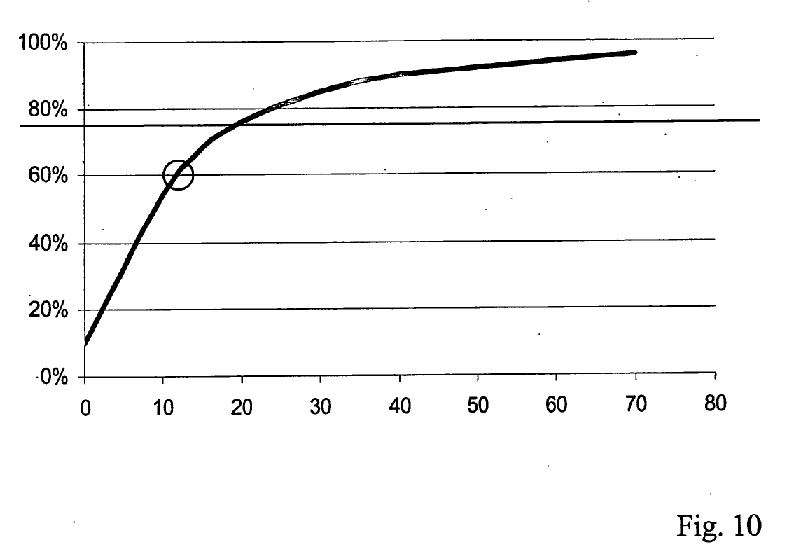

FIG. 10 the efficiency of the sequence as a function of the number of available spaces in the sorting buffer;

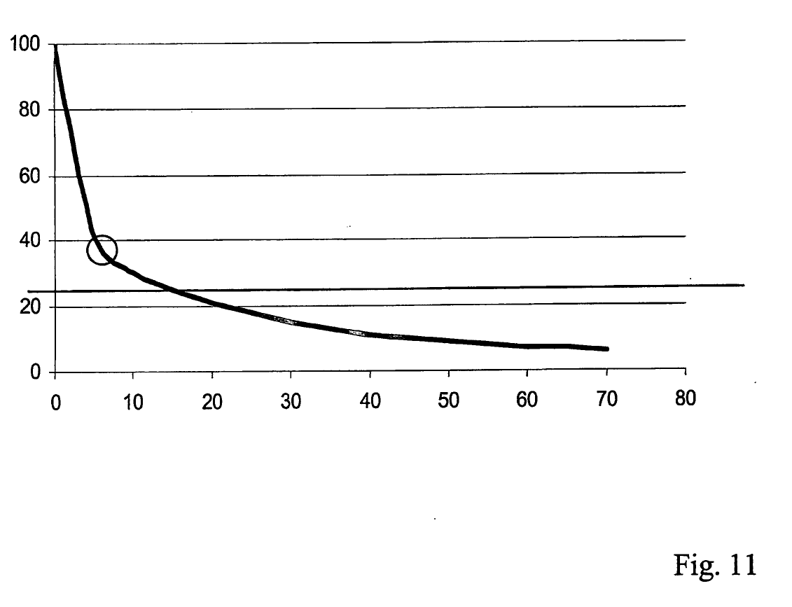

FIG. 11 the maximum postfetching as a function of the number of available spaces in the sorting buffer.

The exemplary embodiment of the present invention described in the following relates to a production process for manufacturing motor vehicles. This production process encompasses the following ten stations through which a production object cycles in succession, in order to manufacture a motor vehicle out of the same:
vehicle scheduling
lead-time logistics 100.1: the lead time required for the production, for example in order to notify and/or place orders with suppliers;
body-in-white 100.2;
surface finishing 100.3, in particular painting;
production logistics 100.4, which, in particular, takes into account the time periods for
transportation within the production facility;
the different working hours at the “stations”;
and arranging the products in the order in which the subsequent subprocesses will need them;
interior assembly 100.5, as a subprocess which combines all assembly operations in the interior of the motor vehicle, such as dashboard assembly, seats, and trim;
chassis and suspension 100.6, as a subprocess which combines all assembly operations from below, such as engine, drive train, axles, wheels, and cables;
breaking-in 100.7, including adjustments to the lighting systems, brakes, and suspension, for example;
vehicle completion 100.8, including any required reworking; and
final inspection.

The vehicle scheduling and final inspection do not require any cycle times, so they are not considered in the following. FIG. I illustrates the order in which the production objects cycle through the other eight stations in the production process.

Each station includes one or more subprocesses. The subprocesses are delimited from each other in such a way that no subprocesses are carried out in parallel or alternatively. Rather, the subprocesses are defined in such a way that any branching thereof occurs only within a subprocess. For example, subprocess 100.3 (“surface finishing”) includes the two work steps 110.1 (““base coat finish”) and 110.2 (“top coat finish”). In work step 110.1, the production objects completed in the body-in-white station undergo a cathodic dip painting, which is followed by the application of a base coat (“filler”). The top coat, which determines the color of the motor vehicle, is subsequently applied in work step 110.2. A clear-coat finish is then added. Depending on the specified color, the top coat and, as a function thereof, the base coat are selected.

In accordance with the present invention, a sequence 70 of production objects 20.1, 20.2, . . . cycles through this production process, from start to finish. In the beginning, the production object exists only “on paper”; at the end of the production process, a completed motor vehicle has been produced. In parallel thereto, a sequence 50 of orders 10.1, 10.2, . . . cycles through the same production process. In this example, each order relates to a motor vehicle. This motor vehicle is manufactured in accordance with order-specific instructions, thus, in such a way that it meets the customer's requirements specified in the order. Typically, the production object does not begin its cycle through the production process until the order is at hand. Each motor vehicle is preferably manufactured on the basis of an order. Each order relates to a buildable motor vehicle, and the execution of each order is at least begun upon receipt of the order. As a result, the exact same number of orders and production objects cycle through the production process.

Additional fictitious orders, which relate to an unfinished motor vehicle, are also preferably generated. A production object is manufactured, for example, on the basis of such a fictitious order, and is then intentionally destroyed in a test or trial during production.

The motor vehicles are preferably manufactured in a fixed-cycle production in the production process. A planned cycle time T is predefined for the entire production process. Two consecutive production objects of production-object sequence 70 are delivered at time interval T to a subprocess.

The order exists in electronic form and includes, for instance, the following specifications for a motor vehicle as a product to be manufactured in accordance with order-specific instructions:
the model series;
a body version, such as limousine or coupe,
left-hand drive or right-hand drive;
color of the paint finish;
type of paint finish (for instance, metallic paint finish),
an engine variant;
all-wheel drive or single-axle drive;
with or without a sunroof;
with or without the rear-seat pass-through option in the vehicle interior;
with or without a trailer hitch;
desired special appointments for the interior assembly, such as specific leathers or fabrics, or an electronic navigational assistance;
desired options for the chassis and suspension system, including the drive train, such as fuel delivery system, wheel rims;
electronic auxiliary systems, such as power windows or electronic brake assist system;
and an agreed-upon delivery date, as well as a scheduled final inspection date derived therefrom.

Data records of a database describe the orders of the order sequence. A data record for an order is created upon receipt of the order. The data record remains in the database until a motor vehicle has been completed in accordance with the order, and an invoice has been issued and paid. Another set of data records in the database describes the production-object sequence. The data record of a production object includes the feature characteristics of the production object manufactured up to that point. Once a production object has cycled through subprocess 100.3, the data record includes, inter alia, the following information about the production object:
color of the base coat finish;
color of the top coat finish;
type of top coat finish.

From the scheduled final inspection date for each order, one derives, on the one hand, the start of production for this order, and, on the other hand, the delivery dates for the supplied subsystems. To this end, a retrospective calculation is made, starting from the final inspection date, as a function of attainable cycle times through subprocesses and in dependence upon available resources.

A so-called order penetration point 300 is defined in the production process. This order penetration point 300 is the point where a binding mutual assignment of order sequence 50 and production-object sequence 70 is made. Thus, from this point on, an order is permanently assigned to each production object of sequence 70. Order penetration point 300 is placed in the production process in such a way that, on the one hand, it occurs as far back in the production process as possible, and, on the other hand, in such a way that many subprocesses, in which subsystems having a wide range of variants and often varying from order to order are installed in the production object, do not occur until after the order penetration point. In this example, the order penetration point has been placed immediately upstream of the interior assembly. The order sequence is altered at the order penetration point if the need arises, such as when the first production object and the first order do not match.

Orders are placed with the suppliers who deliver the subsystems which are installed in subprocesses downstream of order penetration point 300, on the basis of order sequence 50. A supplier may be an external supplier, i.e., a legally independent business entity, or an internal supplier, i.e., a division of the vehicle manufacturer. The production control according to the present invention does not make any distinction between internal and external suppliers. Some subsystems, such as casting molds for cylinder heads, are needed for manufacturing order-specific production objects, but are not installed in them.

Orders for suppliers are derived from each order of order sequence 50 by using a parts list of the motor vehicle. It may be necessary to manufacture a plurality of units of the subsystem for one motor vehicle, such as four seats per motor vehicle. This gives rise to a supply-order sequence for each supplier.

Order penetration point 300 is placed as far back as possible in the production process. In this way, the suppliers are given a longest possible lead time, namely the time between the entry of the production object in first subprocess 100.1 of the production process and the reaching of order penetration point 300. Order penetration point 300 is preferably placed upstream of subprocess 100.5 (“interior assembly station”). Considered collectively, the subsystems produced for the interior assembly, such as cable trees, dashboard assembly, and seats, are so order-specific that they can generally only be used for one single production object.

One selection point, whose function is described in the following, resides upstream of each of the following subprocesses:
selection point 200.2 upstream of subprocess 100.2 (body-in-white station);
selection point 200.3 upstream of subprocess 100.3 (surface finishing station); and
order penetration point 300, as the selection point upstream of subprocess 100.5 (interior assembly station).

A sorting buffer having spaces for production objects is provided at those selection points in which physical production objects are selected. In the example of FIG. 1, selection point 200.3 having sorting buffer 500.3 and order penetration point 300 having sorting buffer 500.5 are provided. Subprocess 100.1 does not yet supply any physical production objects, so there is no need for a sorting buffer. Each of these sorting buffers preferably allows a random access to each production object placed therein.

At least one additional sorting buffer is preferably provided for subsystems produced on the basis of the order sequence installed downstream of order penetration point 300. A subsystem of this kind is placed in a sorting buffer for subsystems, when the production object into which the subsystem is to be installed, arrives at the installation location later than scheduled. FIG. 1 shows a sorting buffer 500.6 for subsystems that are installed in subprocess 100.5.

At each of these selection points, a selection process is repeatedly carried out, in which an order from the order sequence and a production object from the production-object sequence or residing in the sorting buffer, which match one another, are selected. In this comparison, the features of an order are preferably compared to those features of a production object that are produced or modified in the subsequent subprocess, and not to those that remain unchanged in the subprocess. The selected production object is delivered to the subsequent subprocess, where it is processed in accordance with the selected order.

An order is compared to a production object by comparing the data record for the order to the data record for the production object. This comparison is preferably performed fully automatically, without any human intervention.

In the preferred specific embodiment, the selection processes are carried out by an industry-standard master computer used for production control. This master computer used for production control has built-in redundancy and thus minimal downtime. The master computer used for production control has read and write access to the database having the data records for orders and production objects.

As described above, a matching production object and order are selected at every selection point in each selection process. Each of the subprocesses having an upstream selection point is preferably assigned a selection subset of those features that were produced in the preceding subprocesses. A production object and an order are assessed as matching one another when every product feature of the order belonging to the selection subset, is consistent with all of the features of the production object.

As a feature, each selection subset preferably includes the target completion date required by the subprocess, thus, the latest date by when a production object matching the order must have been processed in the subprocess in accordance with the order and have exited the subprocess.

In addition, each subprocess is assigned a processing subset. The features of the processing subset of a subprocess 100.x are processed in subprocess 100.x. A processing order for the subprocess is derived with the aid of the features of a selected order and the features of the processing subset. The production object is derived in the subprocess in accordance with the processing order.

For example, a selection subset having the following features is assigned to subprocess 100.2 (body-in-white station):
model series;
body version.

The processing subset of subprocess 100.2 includes the following features, for example:
model series;
body version;
left-hand drive or right-hand drive;
with or without a sunroof;
with or without trailer hitch.

Features, such as the color and type of paint finish or the engine version, which do not yet play a role in subprocess 100.2, but rather first in subsequent subprocesses, are neither included in the selection subset nor in the processing subset of subprocess 100.2.

At selection point 200.2, a production object of a specific model series and of a specific body version is selected for subprocess 100.2. The work order derived is for manufacturing a production object of this model series and this body version including the features “left-hand drive” and “sunroof”.

The selection subset of subprocess 100.3 (surface finishing station) includes the following features, for example:
model series
body version
left-hand drive or right-hand drive
with or without a sun roof
with or without trailer hitch.

The processing subset of subprocess 100.3 includes the following features, for example:
model series
body version
color of the base coat finish
color of the top coat finish
type of top coat finish.

At selection point 200.3, for example, a production object of a specific model series and of a specific body version having the features “left-hand drive” and “sunroof” is selected for subprocess 100.5 and for a scheduled final inspection date. The work order derived for subprocess 100.5 stipulates a specific color, as well as the type of paint finish to be used for painting this production object.

The selection subset of subprocess 100.5 (interior installation station) includes the following features, for example:
model series
body version
left-hand drive or right-hand drive
with or without a sun roof
color of the base coat finish
color of the top coat finish
type of top coat finish.

The processing subset of subprocess 100.5 (interior installation station) includes the following features, for example:
model series
body version
left-hand drive or right-hand drive
with or without a sun roof
with or without rear-seat pass-through option in the passenger compartment
with or without trailer hitch
desired special appointments for the interior assembly.

A processing subset is also predefined for subprocess 100.6 (chassis and suspension station). There is no need for a selection subset, because an order is permanently assigned to a production object at order penetration point 300.

During a selection process, the production objects in the sorting buffer are searched through to locate a production object which matches the first order of the order sequence. If a matching production object is found, it is selected together with the first order. The selected production object is removed from the sorting buffer and delivered to the first subprocess.

If no production object matching the first order of the order sequence is found in the sorting buffer, then the first order is compared to the production objects in the production-object sequence, in succession, and, to be precise, beginning with the first production object. It is checked whether free spaces are still available in the sorting buffer for all production objects residing in the production-object sequence upstream of a production object that matches the first order. In the case that sorting buffer has altogether N spaces and N_{—}1 of these spaces are already occupied by production objects, and in the case that N_{—}2 non-matching production objects are located upstream of the first matching production object of the production-object sequence, it is then checked whether N>=N_{—}1+N_{—}2. If this condition is fulfilled, the N_{—}2 non-matching production objects are placed in the sorting buffer, and the first matching production object and the first order are selected.

If, on the other hand, N<N_{—}1+N_{—}2, then it is not possible to move up a production object that matches the first order and to deliver it to the particular subprocess that follows, simply by using the sorting buffer. For such cases, an electronic buffer memory for orders is provided at each selection point. In the example of FIG. 1, these are buffer memories 400.2 at selection point 200.2, 400.3 at selection point 200.3 and 400.5 at order penetration point 300. Thus, when it is not possible to move up a production object matching the first order by using the sorting buffer, the first order is removed from the order sequence and placed in the corresponding buffer memory.

It is preferably ensured that an order does not remain in such a buffer memory longer than a predefined maximum dwell time. For that reason, when the dwell time of at least one order in the buffer memory up to that point is greater than or equal to a predefined dwell-time limit, the following steps are implemented during a selection process:
The order having the longest dwell time in the buffer memory and a matching production object from the production-object sequence are selected.
The selected order is removed from the buffer memory.
The selected production object is moved up to the first position in the production-object sequence.

Upstream of this order penetration point 300, an order is assigned to a production object only temporarily, for example, for the particular subprocess that follows; and an order may be assigned in one subprocess to one production object and, in a subsequent subprocess, to another production object. A copy of the order sequence is generated at the selection points upstream of order penetration point 300, thus, in the example of FIG. 1, at selection points 200.2 and 200.3. The selection processes are carried out for the orders in this copy instead of for the orders in the original order sequence. The original order sequence remains unchanged. In the case that no production object of the production-object sequence matching the first order of the copy is able to be moved up to the first position, the copy is placed in the buffer memory and removed from the buffer memory again when the dwell-time limit described above is reached.

A sorting buffer for production objects preferably includes N sorting sub-buffers SB_{—}1, . . . , SB_N. A production object is able to be placed in a selected sorting sub-buffer regardless of the fill level and the capacity utilization of the other sorting sub-buffers. All sorting sub-buffers preferably have the same number of spaces for production objects. Each sorting sub-buffer is formed as a lane. A distribution device in the form of at least one cross conveyor, including a storage and retrieval system having a production object placed thereon, traverses between these lanes. This cross conveyor is able to pick up a production object that is to be placed, from the production-object sequence and place the same in the selected lane. In addition, it is able to remove a production object, which has been placed in a lane, from the lane and deliver it to the subprocess.

Using a valuation function, when a production object is to be placed in the sorting buffer, and one of the sorting sub-buffers is to be selected for this purpose, a current valuation is computed for each sorting sub-buffer with respect to the production object. For each sorting sub-buffer SB_k, this valuation function produces a weighted analysis of the n individual criteria C_{—}1(SB_k), . . . , C_n(SB_k), using n predefined weighting factors ω_{—}1, . . . ω_{—n, where ω}_{—}1+ . . . +ω_{—n=}1. Algorithm val(SB_k)=ω_{—}1*C_{—}1(SB_k)+ . . . +ω_n*C_n(SB_k) is used to compute valuation val(SB_k). The sorting sub-buffer receiving the highest valuation is selected.

One alternative specific embodiment provides for initially arranging the sorting sub-buffers in a sequence according to each individual criterion, the sorting sub-buffers being sorted in descending order according to the valuations with respect to this individual criterion. As a result, altogether n sequences are produced. Each sorting sub-buffer thereby receives n place numbers in these n sequences. The first sorting sub-buffer in a sequence receives place number 1, the subsequent one, place number 2, and so forth. The n place numbers of a sorting sub-buffer are subsequently added. That sorting sub-buffer is selected for which the smallest sum of place numbers is obtained. The production object is placed in this selected sorting sub-buffer.

The following individual criteria enter into the valuation function:
the current fill level of sorting sub-buffer SB_k, which is the current total number of production objects in sorting sub-buffer SB_k,
the current capacity utilization of sorting sub-buffer SB_k, which is the current number of those production objects in the sorting sub-buffer that were selected in a previous selection process, but were not yet removed from the sorting sub-buffer,
the current total number of those production objects in the sorting sub-buffer SB_k, which differ by at least one feature in each case from the production object to be placed,
and the expenditure of time required to place the production object to be placed, into sorting sub-buffer SB_k.

When selecting a sorting sub-buffer, it is a goal for as many variants of production objects as possible to reside in each sorting sub-buffer, and at all times. The closer one comes to reaching this goal, the less of an effect a downtime experienced by a sorting sub-buffer has on the processing of the order sequence.

When selecting a sorting sub-buffer, it is preferably first determined which sorting sub-buffers are currently empty, and, among these empty sorting sub-buffers, one is selected, for example the one into which the production object is able to be placed in the least amount of time. Typically, this single criterion is only dependent on the geometry of the sorting buffer and possibly on the production line, but not on the individual production objects or orders.

In the case that a sorting sub-buffer is experiencing downtime due to a breakdown, it is not considered during the selection process until it is available again. It is also possible that some production objects are only able to be placed in a few of the sorting sub-buffers, for example because of their dimensions or because they require a specific ambient temperature. In such a case, it is ascertained before the selection process, which sorting sub-buffers come under consideration at all, for placing the production object.

One refinement provides for modifying the third single criterion in such a way that, the greater the dissimilarity between the production object to be placed and the production objects actually residing in the sorting sub-buffer, the higher the degree of priority is given to a sorting sub-buffer. In the case that the production objects in a sorting sub-buffer are dissimilar to one another and, for that reason, similar production objects are always distributed over different sorting sub-buffers, there is then a greater probability that a production object matching the first order can be removed from the sorting buffer, even when one sorting sub-buffer is experiencing downtime due to a breakdown, making it necessary to revert to other sorting sub-buffers.

The following algorithm is preferably used to determine the value for sorting sub-buffer SB_{—}1 with respect to the third single criterion:

Let PO be the production object to be placed and let PO_{—}1, . . . , PO_m be the m production objects residing in SB_{—}1 before PO is placed. The orders and production objects are compared on the basis of r attributes A⁽¹⁾, . . . , A^{(r)}. Examples of attributes are engine versions, left-hand drive or right-hand drive, and the presence or absence of special appointments. Let ω⁽¹⁾, . . . , ω^{(r)} be predefined weighting factors for the r attributes. For the r attributes, r distance measures dist⁽¹⁾, . . . , dist^{(r)} are defined. For s=1, . . . , r, dist^{(s)} defines a measure of the dissimilarity between two possible attribute values a and b of attribute A^{(s)}. Frequently, dist^{(s)} (a,b)=1, in the case that a is equal to b, and dist^{(s)}(a,b)=0, in the case that a is unequal to b. Another measure of the dissimilarity is preferably defined for an attribute, for example, which relates to the color of the paint finish of motor vehicles. The greater the deviation between two different paint colors, the greater is the value for dist. Considered here are the outlay entailed in converting a painting line from one color paint to another color paint, and the effects that residual particles of the old color paint have on a paint finish in a new color paint.

Let a⁽¹⁾, . . . , a^{(r)} be the attribute values of production object PO to be placed. For k=1, . . . , m let bₖ⁽¹⁾, . . . , bₖ^{(r)} be the attribute values of production object PO_k, which already resides in sorting sub-buffer SB_{—}1. The value with respect to the third single criterion is denoted by dist(PO, SB_{—}1) and is a measure of the dissimilarity of PO from m production objects PO_{—}1, . . . , PO_m in sorting sub-buffer SB_{—}1. Algorithm dist(PO, SB_{—}1)=min {dist (PO, PO_{—}1), . . . , dist (PO, PO_m)} is used to calculate this value. For k=1, . . . , m, dist(PO, PO_k) is a measure of the dissimilarity between PO and PO_k, which is calculated in accordance with algorithm dist(PO, PO_k)=ω⁽¹⁾*dist⁽¹⁾(a⁽¹⁾, bₖ⁽¹⁾) . . . +ω^{(r)}*dist^{(r)}(a^{(r)}, bₖ^{(r)}).

Orders 10.1, 10.2, 10.3, . . . from customers for vehicles of a specific model series are arranged in an order sequence 50. The manufacturing of production objects for products of this model series is begun on the basis of this order sequence 50. One after another, these production objects exit subprocess 100.2 (body-in-white station) in production-object sequence 20.1, 20.2, 20.3 . . . . A copy 60 of this order sequence 50 is generated, including order copies 10.1, 10.2, 10.3, . . . .

Value 3*T, thus three cycle times, for example, is predefined as dwell-time limit DL for electronic buffer memory 400.3 of selection point 200.3. Thus, a limit of three selection processes is derived. This limit results from the following compromise:

When an order in the buffer memory reaches the dwell-time limit, the attempt is made to find a matching production object for this order. In the case that the first matching production object is not the first of the production-object sequence, then the production objects upstream of the first matching are searched through.

One consideration is that as few orders as possible be processed behind schedule.

The following describes in detail the execution of selection processes. FIGS. 2 through 7 show snapshot views of sequences 50, 60 and 70, as well as the contents of buffer memory 400.3 and the stock of sorting buffer 500.3 after the first, second, fourth, seventh and, respectively, ninth selection process. A double arrow links the last production object to be selected in each case and the selected order. A matching selected order and selected production object are characterized by the same type of hatching. A number inside of a circle denotes the dwell time of an order, measured in cycles.

The selection processes at selection point 200.3 for the current model series begin at point in time T_{—}0 and take place at points in time T_i=T_{—}0+i*T (i=0, 1, 2, 3, . . . ). The time required for executing a selection process is short in comparison to cycle time T.

At point in time T_{—}0, order 10.1 of copy 60 of order sequence 50 and matching production object 20.1 are selected. Production object 20.1 is delivered to subprocess 100.3 and processed in the same in accordance with selected order 10.1. Selected order 10. I has a relative position of 0 in the selection sequence, in comparison to order sequence 50.

In a snapshot view, FIG. 2 shows the production objects and orders, following execution of this first selection process. The orders and production objects are illustrated as coming from the left. Selected order 10.1 and selected production object 20.1 are hatched and linked by a double arrow. Electronic buffer memory 400.3 and sorting buffer 500.3 for production objects are still empty.

At point in time T_{—}1=T_{—}0+T, it is ascertained that order 10.2 and production object 20.2 do not match, because order 10.2 specifies a left-hand drive, whereas production object 20.2 is a right-hand drive vehicle. Consequently, the other production objects in production-object sequence are compared to order 10.2. It is ascertained that production object 20.4 matches order 10.2. Located upstream of production object 20.4 are two production objects which are both able to be placed in sorting buffer 500.3. Therefore, production object 20.4 is selected and moved up to the first position in the production-object sequence. Order 10.2 is likewise selected, and production object 20.4 is processed in accordance with order 10.2 in the subsequent subprocess 100.3. Therefore, after point in time T_{—}1, the two production objects 20.2 and 20.3 reside in sorting buffer 500.3. In a snapshot view, FIG. 3 shows order sequence 50 and its copy 60, production-object sequence 70, buffer memory 400.3 and sorting buffer 500.3, following execution of the second selection process.

The next order 10.3 in copy 60 or order sequence 70 is first compared to the two production objects in sorting buffer 500.3 at point in time T_{—}2=T_{—}0+2*T. Order 10.3 does not match production object 20.2, because order 10.3 specifies a motor vehicle without a sun roof, whereas production object 20.3 is a motor vehicle with a sun roof. On the other hand, order 10.3 matches production object 20.2. Therefore, these two are selected. Production object 20.2 is removed from the sorting buffer, delivered to subprocess 100.3, and processed in the same in accordance with order 10.3.

The next order 10.4 in copy 60 is compared to production object 20.2 in sorting buffer 500.3 at point in time T_{—}3=T_{—}0+3*T. The two match and are selected. Production object 20.2 is removed from the sorting buffer.

At point in time T_{—}4=T_{—}0+4*T, the production objects of production-object sequence 70 are searched through to find a production object which matches the next order 10.5 of copy 60. The next production object that matches is production object 20.9. To move this production object up to the first position, four free spaces are needed in sorting buffer 500.3, because upstream of 20.9, four other productions objects 20.5 through 20.8 still come before matching production object 20.9. However, sorting buffer 500.3 only has three free spaces. Therefore, no production object matching order 10.5 can be moved up to the first position, and order 10.5 is placed in buffer memory 400.3. The next order 10.6 of copy 60 is compared to the production objects of production-object sequence 70. The next production object that matches is production object 20.7. The two production objects 20.5 and 20.6 located upstream of this matching production object are placed in sorting buffer 500.3. Production object 20.7 and order 10.6 are selected. Selected order 10.7 [sic. 10.6] has a relative position of +1, because it is delivered to subprocess 100.3 one position earlier than that stipulated by original order sequence 50.

In a snapshot view, FIG. 4 shows the production objects and orders in the exemplary embodiment following the fifth selection process, thus following point in time T_{—}4. A number inside of a circle denotes the number of selection processes during which a deferred order has already resided in buffer memory 400.3.

At point in time T_{—}5=T_{—}0+5*T, the orders in buffer memory 400.3 are first compared to production objects in sorting buffer 500.3. The only order 10.5 in the buffer memory had already been compared to production objects 20.5 and 20.6 in sorting buffer 500.3 and been identified as not matching. The first production object of production-object sequence 70 that matches order 10.6, is production object 20.9. This production object can now be moved up to the first position in production-object sequence 70, since, in exchange, only one production object, namely production object 20.8, still needs to be placed in sorting buffer 500.3. Therefore, order 10.6 and production object 20.9 are selected. Production object 20.8 is placed in sorting buffer 500.3 and order 10.6 is removed from buffer memory 400.3. Selected order 10.6 has a relative position of −1.

At selection point in time T_{—}6=T_{—}0+6*T, next order 10.7 is first compared to the three production objects 20.5, 20.6 and 20.8 in sorting buffer 500.3. However, none of the three production objects matches order 10.7. First production object 20.10 of production-object sequence 70 does not match order 10.7 either. Since no more free spaces are available in sorting buffer 500.3, order 10.7 is deferred, in that it is placed in buffer memory 400.3. The next order 10.8 is also first compared to the three production objects in sorting buffer 500.3, however it does not match any of them. On the other hand, order 10.8 matches first production object 20.10 of production-object sequence 70. Therefore, 10.8 and 20.10 are selected. Selected order 10.8 has a relative position of+1.

At selection point in time T_{—}7=T_{—}0+7*T, buffer memory 400.3 is initially searched to find a production object matching order 10.7. The three production objects in sorting buffer 500.3 do not match order 10.7. First production object 20.11 of production-object sequence 70 does not match order 10.7 either. Since no more free spaces are available in sorting buffer 500.3, order 10.7 remains in buffer memory 400.3. The next order 10.9 is also first compared to the three production objects in sorting buffer 500.3, however it does not match any of them. On the other hand, order 10.9 matches first production object 20.11 of production-object sequence 70. Therefore, 10.9 and 20.11 are selected. Selected order 10.9 has a relative position of+1.

In a snapshot view, FIG. 5 shows the production objects and orders in the exemplary embodiment following the eighth selection process.

At point in time T_{—}8=T_{—}0 +8*T, order 10.7 residing in buffer memory 400.3 is first compared to next production object 20.12, however, they do not match. Therefore, order 10.7 remains in buffer memory 400.3. The next order 10.10 does, in fact, match production object 20.15 of production-object sequence 70, but not the next production object 20.12. Since the matching production object 20.13 cannot be moved up to the first position, order 10.10 is likewise placed in buffer memory 400.3. The next order 10.11 matches the next production object 20.12. Therefore, 10.11 and 20.12 are selected. Selected order 10.11 has a relative position of+2.

At point in time T_{—}9=T_{—}0+9*T, it is ascertained that two orders reside in buffer memory 400.3. Order 10.7 has already resided in buffer memory for two selection processes, order 10.10 not yet for any. Therefore, order 10.7 is first compared to the next production object 20.13, however, the two do not match. On the other hand, order 10.10 matches production object 20.13. For that reason, 10.10 and 20.13 are selected, and order 10.10 is removed from buffer memory 400.3. Selected order 10.10 has a relative position of 0.

In a snapshot view, FIG. 6 shows the production objects and orders in the exemplary embodiment following the tenth selection process.

At point in time T_{—}10=T_{—}0+10*T, it is ascertained that order 10.7 has already resided in buffer memory 400.3 for three selection processes. Thus, an upper bound is reached, and the order is treated preferentially. Matching production object 20.15 is not able to be moved up to the first position using sorting buffer 500.3, because no free spaces are available. Therefore, in order to continue, one of the following method steps is carried out:
A production object in sorting buffer 500.3 and the next order in copy 60 that matches it are selected. As a result, a space is made available in sorting buffer 500.3, and production object 20.15 matching order 10.7 can be moved up to the first position.
A procedure is used in order to move up production object 20.15 and to deliver it to subprocess 100.3 without using sorting buffer 500.3. For example, production object 20.15 is transferred out of production-object sequence 70, moved up using a manned transport installation, and delivered to subprocess 100.3.
Order 10.7 and production object 20.13 are selected, although selected order 10.7 and selected production object 20.13 do not match. This option is only utilized when the selected production object can be subsequently made to match the selected order. This is primarily the case when the production object does not match the order, simply because a subsystem for the production object was delivered too late and, instead of being installed in subprocess 100.2, is installed in subsequent subprocess 100.3.
The selection of order 10.7 is canceled, and order 10.7 is marked as not being deliverable to subprocess 100.3 within the maximum time period allowed. Order 10.7 is returned to vehicle scheduling (subprocess 100.1). There, it is rescheduled. It is preferably checked beforehand whether its production is possible in principle or is currently not possible due to an outage, for example. In the case, for example, that order 10.7 specifies all-wheel drive, and the production or delivery of all-wheel drive vehicles is completely stopped at the moment in question, order 10.7 is not scheduled until the stoppage of production of all-wheel drive vehicles is lifted.

The third alternative is not technically feasible for subprocess 100.3. The fourth alternative would lead to a product in accordance with order 10.7 being completed much later than agreed upon. However, the second alternative is frequently not at all practicable, or is expensive and, therefore, seldom used. The first alternative leads to order 10.7 being processed with an even greater delay relative to the scheduled sequence. However, since only one production object needs to be removed from sorting buffer 500.3 for the first alternative, the first alternative is tried first. Thus, in this situation, not only the next selection process, but also the selection process after the next is scheduled.

It is ascertained that order 10.12 does not match any production object in sorting buffer 500.3. On the other hand, production object 20.5 in sorting buffer 500.3 matches order 10.13. Therefore, production object 20.5 and order 10.13 are selected. Production object 20.5 is removed from sorting buffer 500.3 and delivered to subprocess 100.3. Selected order 10.13 has a relative position of+2. Order 10.12 is placed in buffer memory 400.3.

At point in time T_{—}11=T_{—}0+1*T, the sequence already previously established is executed. Production object 20.14 is placed in the sorting buffer. Order 10.7 and production object 20.15 are selected. Order 10.7 is removed from buffer memory 400.3. Selected order 10.7 has a relative position of−5.

At point in time T_{—}12=T_{—}0+12*T, remaining order 10.12 in buffer memory 400.3 is first compared to the three production objects in sorting buffer 500.3. It is ascertained that order 10.12 matches production object 20.6. Therefore, 10.12 and 20.6 are selected. Order 10.12 is removed from buffer memory 400.3; production object 20.6 from sorting buffer 500.3.

FIG. 7 illustrates the situation arrived at, at this point.

At point in time T_{—}13=T_{—}0+13*T, it is ascertained that order 10.14 matches production object 20.8. Therefore, both are selected, and 20.8 is removed from sorting buffer 500.3. At point in time T_{—}14=T_{—}0+14*T, it is ascertained that order 10.15 matches production object 20.14. Therefore, both are selected, and 20.14 is removed from sorting buffer 500.3. Thus, in this example, copy 60 of order sequence 50 and, thus, also order sequence 50 are processed.

The table in the following illustrates the sequence of the selection processes. The figures, which indicate the situation arrived at in each case, are entered. In this case:
point in time: signifies number i of selection point in time T_i;
first order: denotes the first order in copy 60 of order sequence 50 prior to implementing selection order no. i;
first PO: first production object in production-object sequence 70 prior to implementing selection process no. i;
contents buffer memory: contents of electronic buffer memory 400.3 after implementing selection process no. i, the respective dwell time being indicated in square brackets;
stock of sorting buffer: stock of sorting buffer 500.3 after implementing selection process no. i;
selected order: the order selected from the copy in selection process no. i;
selected PO: the production object selected in selection process no. i from production-object sequence 70;
relative position: the relative position of the selected order.

| | | 1^{st} | Contents | Stock of | | Selected | |
|---|---|---|---|---|---|---|---|
| Point in | | Production | Buffer | Sorting | Selected | Production | Relative |
| Time | 1^{st} Order | Object | Memory | Buffer | Order | Object | Position |
| 0 | 10.1 | 20.1 | ./. | ./. | 10.1 | 20.1 | 0 |

FIG. 2

| | | | | | | | |
|---|---|---|---|---|---|---|---|
| 1 | 10.2 | 20.2 | ./. | 20.2, | 10.2 | 20.4 | 0 |
| | | | | 20.3 | | | |

FIG. 3

| | | | | | | | |
|---|---|---|---|---|---|---|---|
| 2 | 10.3 | 20.5 | ./. | 20.3 | 10.3 | 20.2 | 0 |
| 3 | 10.4 | 20.5 | ./. | ./. | 10.4 | 20.3 | 0 |
| 4 | 10.5 | 20.5 | 10.5 [0] | 20.5, | 10.6 | 20.7 | +1 |
| | | | | 20.6 | | | |

FIG. 4

| | | | | | | | |
|---|---|---|---|---|---|---|---|
| 5 | 10.7 | 20.8 | ./. | 20.5, | 10.5 | 20.9 | −1 |
| | | | | 20.6, | | | |
| | | | | 20.8 | | | |
| 6 | 10.7 | 20.10 | 10.7 [0] | 20.5, | 10.8 | 20.10 | +1 |
| | | | | 20.6, | | | |
| | | | | 20.8 | | | |
| 7 | 10.9 | 20.11 | 10.7 [1] | 20.5, | 10.9 | 20.11 | +1 |
| | | | | 20.6 | | | |
| | | | | 20.8 | | | |

FIG. 5

| | | | | | | | |
|---|---|---|---|---|---|---|---|
| 8 | 10.10 | 20.12 | 10.7 [2], | 20.5, | 10.11 | 20.12 | +2 |
| | | | 10.10 [0] | 20.6, | | | |
| | | | | 20.8 | | | |
| 9 | 10.12 | 20.13 | 10.7 [3] | 20.5, | 10.10 | 20.13 | 0 |
| | | | | 20.6, | | | |
| | | | | 20.8 | | | |

FIG. 6

| | | | | | | | |
|---|---|---|---|---|---|---|---|
| 10 | 10.12 | 20.14 | 10.7 [4], | 20.6, | 10.13 | 20.5 | +2 |
| | | | 10.12 [0] | 20.8 | | | |
| 11 | 10.14 | 20.14 | 10.12 [1] | 20.6, | 10.7 | 20.15 | −5 |
| | | | | 20.8, | | | |
| | | | | 20.14 | | | |
| 12 | 10.14 | ./. | ./. | 20.8, | 10.12 | 20.6 | −1 |
| | | | | 20.14 | | | |

FIG. 7

| | | | | | | | |
|---|---|---|---|---|---|---|---|
| 13 | 10.14 | ./. | ./. | 20.14 | 10.14 | 20.8 | 0 |
| 14 | ./. | ./. | ./. | ./. | 10.15 | 20.14 | 0 |

In this example, 4 of the 15 orders were placed in the buffer memory, and 7 of the 15 orders have neither undergone a prefetching nor a postfetching, but are faithful-to-position.

As already described above, a data record in a database is generated for each order and each production object. An industry-standard master computer used for production control has read and write access to this database. It is possible to realize each electronic buffer memory as a separate database and to physically copy data records. Computing time and memory capacity are saved when no data records are copied. Instead, additional data fields are created and modified when implementing the method. This is described in the following.

For one order, each data record includes the following data fields.
data fields for the above described specifications relating to the motor vehicle that is to be manufactured on the basis of the order, for example color of the paint finish and desired special appointments;
setpoint position, i.e., the position of the order in order sequence 50;
an identifier for that production object currently being processed on the basis of the order;
an identifier for that subprocess in which a production object is currently being processed in accordance with the order;
actual position, i.e., the position of the order in copy 60 of the order sequence;
an identifier for that electronic buffer memory in which the order currently resides;
for each subprocess, the two specified points in time at which the processing of a production object is supposed to begin or end in accordance with the vehicle scheduling and as specified by the order;
for each subprocess, the two actual points in time at which the processing of a production object in accordance with the order is actually begun or ended.

The selection processes are advantageously logged at each selection point. In this connection, a log recording the order and production object that are selected is generated each time. Thus, the log generated at a selection point 200.x includes a series of pairs, each including one order and one production object matching the order. The information pertaining to an order includes a unique identifier. The information pertaining to one production object likewise includes a clear identifier, as well as the characteristics of the production object with respect to all of the features which were processed in one of the subprocesses prior to selection point 200.x and, therefore, which belong to the above described processing subset of one of these subprocesses.

A data record for a production object includes the following data fields:
an identifier for that subprocess in which the production object is currently being processed;
an identifier for that order on whose basis the production object is currently being processed;
the position of the production object in production-object sequence 70;
an identifier for the sorting buffer in which the production object currently resides.

When an order is “waiting” for a subprocess, thus when a production object had been processed in a preceding subprocess on the basis of the order, and the production object had exited from the preceding subprocess, but had not yet been selected for the next subprocess, that subprocess is noted for which the order is waiting. The data field for an electronic buffer memory is, of course, only filled when an order of the copy had been placed in the electronic buffer memory. After the order is removed from the electronic buffer memory, the data field for the buffer memory is emptied.

In the example of FIG. 4, the setpoint position of order 10.1 is one, that of order 10.2 is two, and so on. The actual position of order 10.1 is one, that of order 10.2 is four, that of order 10.4 is two, and so on. After the fourth selection process, order 10.3 does not have any setpoint position. An identifier for buffer memory 400.3 is noted in the corresponding data field.

When carrying out a selection process, the master computer used for production control searches through the data records for orders and, in each case, searches for a matching production object and order. If they are found, an identifier for the selected production object is noted in the data record for the selected order. Conversely, an identifier for the selected order is noted in the data record for the selected production object. The data fields “actual position” of the order data record and “position” of the production object are filled with the current values. The copy of the order sequence is generated in that the data fields “actual position” of the order data records are filled and modified. As soon as an order reaches “order penetration point” 300, the values in “actual position” and “setpoint position” are identical, so that only the value of “setpoint position” is still needed.

The data fields “actual position”, “actual points in time”, “electronic buffer memory” and “production object of the order data records”, as well as “position” and “order” of the production-object data records are preferably emptied at regular intervals and described using the current values. These current values are ascertained beforehand. In this manner, a defined starting point is created at regular intervals. For example, preventive maintenance on the entire production process is performed each night. During these maintenance procedures, the just mentioned data fields are emptied and filled with the ascertained current values.

By automatically evaluating the log generated at selection point 200.x, the positional quality described in the following, of the preceding subprocess is able to be ascertained.

By automatically evaluating the log from selection point 200.3, the positional quality of subprocess 100.2 is able to be ascertained, for example. The sequence of the orders in the order sequence prior to subprocess 100.2 is compared to the sequence subsequent to subprocess 100.2 In the preferred specific embodiment, a copy 60 of order sequence 50 is generated at selection point 200.3. Instead of the original order sequence, only the copy is altered by the selection processes at selection point 200.3. For that reason, after the selection processes are carried out, the copy is compared to the original.

In the example illustrated by FIGS. 2 through 7, once they have exited sorting buffer 500.3, the selected orders have the following relative positions, which are ascertained by comparing copy 70 to original 60.

| Order | Relative Position |
|---|---|
| 10.1 | 0 |
| 10.2 | 0 |
| 10.3 | 0 |
| 10.4 | 0 |
| 10.5 | −1 |
| 10.6 | +1 |
| 10.7 | −5 |
| 10.8 | +1 |
| 10.9 | +1 |
| 10.10 | 0 |
| 10.11 | +2 |
| 10.12 | −1 |
| 10.13 | +2 |
| 10.14 | 0 |
| 10.15 | 0 |

In this example, the greatest degree of prefetching, that is the largest relative position, amounts to+2 positions. Because, in this example, the sorting buffer can only accommodate three production objects, an upper bound of three is set on the prefetching operation. The greatest degree of postfetching, that is the amount of the smallest relative position, amounts to five positions.

A histogram can be used to illustrate the positional quality that is attainable using sorting buffer 500.3. FIG. 8 shows such a histogram for the fourteen selection processes which are illustrated by FIGS. 2 through 7, and by the above table. Because the production objects are processed in a fixed-cycle production and a fixed cycle time of, for example, two minutes is preset, a prefetching and a postfetching are able to be calculated in minutes from the histogram. A prefetching of two positions corresponds to a prefetching of 2 * 2 min=4 minutes; a postfetching of five positions corresponds to a postfetching of 5 * 2 min=10 minutes.

The generated logs described above for a reference type of production object are used for sizing the sorting buffer for a type to be produced later. This is described on the basis of the example of selection point 200.3 using sorting buffer 500.3. A log is used including original order sequence 50 and sequence 70 of production objects in the sequence in which the production objects exited preceding subprocess 100.2. The logged original sequence functions as a reference sequence of reference orders. Logged sequence 70 of the production objects functions as an electronic copy of the reference production-object sequence.

In this example, the following possible values are predefined for the maximum number of available spaces of sorting buffer 500.3 for the production objects: 0, 3, 6 and 9 spaces. An electronically available model of sorting buffer 500.3 is generated. This model can be set to a predefined maximum number of available spaces.

A simulation is performed for each one of the predefined possible values. In this simulation, the model of sorting buffer 500.3 and electronic buffer memory 400.3 are used.

The simulation is performed for three storage spaces precisely in the manner described above. The following table clarifies the simulation for zero storage spaces, thus for the case that no sorting buffer at all is provided. In this simulation, the following strategy is used in the selection processes:
The orders in buffer memory are first compared to the first production object of production-object sequence 70. If, in so doing, an order is found that matches the first production object, then the order and production object are selected, and the order is removed from the buffer memory.
Otherwise, the first production object of production-object sequence 70 is compared to the orders of the order sequence. The first production object and the first matching order are selected. All orders upstream of the first matching order are placed in the buffer memory. In the case that the first order already matches the first production object, no order is placed in the buffer memory.
Methods for moving up a production object to the first position without the use of a sorting buffer, are not used during the simulation.

| | | 1^{st} | Contents | Stock of | | Selected | |
|---|---|---|---|---|---|---|---|
| Point in | | Production | Buffer | Sorting | Selected | Production | Relative |
| Time | 1^{st} Order | Object | Memory | Buffer | Order | Object | Position |
| 0 | 10.1 | 20.1 | ./. | ./. | 10.1 | 20.1 | 0 |
| 1 | 10.2 | 20.2 | 10.2 [0] | ./. | 10.3 | 20.2 | +1 |
| 2 | 10.4 | 20.3 | 10.2 [1] | ./. | 10.4 | 20.3 | +1 |
| 3 | 10.5 | 20.4 | ./. | ./. | 10.2 | 20.4 | −2 |
| 4 | 10.5 | 20.5 | 10.5 [0], | ./. | 10.13 | 20.5 | +8 |
| | | | . . . | | | | |
| | | | 10.12 [0] | | | | |
| 5 | 10.14 | 20.6 | 10.5 [1], | ./. | 10.12 | 20.6 | +6 |
| | | | . . . | | | | |
| | | | 10.11 [1] | | | | |
| 6 | 10.14 | 20.7 | 20.5 [2], | ./. | 10.6 | 20.7 | −1 |
| | | | 10.7 [2], | | | | |
| | | | . . . | | | | |
| | | | 10.11 [2] | | | | |
| 7 | 10.14 | 20.8 | 10.5 [3], | ./. | 10.14 | 20.8 | +6 |
| | | | 10.7 [3], | | | | |
| | | | . . . | | | | |
| | | | 10.11 [3] | | | | |
| 8 | 10.15 | 20.9 | 10.7 [4], | ./. | 10.5 | 20.9 | −4 |
| | | | . . . | | | | |
| | | | 10.11 [4] | | | | |
| 9 | 10.15 | 20.10 | 10.7 [5], | ./. | 10.8 | 20.10 | −2 |
| | | | 10.9 [5], | | | | |
| | | | . . . | | | | |
| | | | 10.11 [5] | | | | |
| 10 | 10.15 | 20.11 | 10.7 [5], | ./. | 10.9 | 20.11 | −2 |
| | | | 10.10[5], | | | | |
| | | | 10.11 [5] | | | | |
| 11 | 10.15 | 20.12 | 10.7 [6], | ./. | 10.11 | 20.12 | −1 |
| | | | 10.10 [6] | | | | |
| 12 | 10.15 | 20.13 | 10.7 [6] | ./. | 10.10 | 20.13 | −3 |
| 13 | 10.15 | 20.14 | 20.7 [7] | ./. | 10.15 | 20.14 | +1 |
| 14 | ./. | 20.15 | ./. | ./. | 10.7 | 20.15 | −8 |

In this example, 14 of the 15 orders were placed in the buffer memory, and only one of the orders has neither undergone a prefetching nor a postfetching operation, but is faithful-to-position. As a secondary result, the simulation reveals the quality of subprocess 100.2 without the use of sorting buffer 500.3, because, inter alia, the maximum postfetching and prefetching, as well as the average faithfulness-to-position are ascertained.

For each of the predefined possible values, the following quality parameters are determined by the simulations:
the greatest value of all relative positions;
the smallest value of all relative positions;
the average value of all relative positions;
and the sequence efficiency i.e., the proportion of those orders in the total number of orders, whose relative position is equal to zero and which are faithful-to-position.

FIG. 10 illustrates the sequence efficiency as a function of the number of spaces in sorting buffer 500.3. In FIG. 10, the number of available spaces in the sorting buffer is plotted on the x-axis; the sequence efficiency resulting in each case is plotted on the y-axis. FIG. 11 shows the maximum postfetching as a function of the number of available spaces in sorting buffer 500.3. In FIG. 11, the number of available spaces in the sorting buffer is plotted on the x-axis; the maximum postfetching resulting in each case is plotted on the y-axis.

An operating point is selected on one of these functions. A number of available spaces is defined by the selection. Preferably, a lower bound of, for example, 75% is preset on the sequence efficiency, or an upper bound of, for example, 25 relative positions on the maximum postfetching. Because acquiring and operating the sorting buffer is all the more expensive, and because all the more space the sorting buffer takes up, the more spaces it has, it is designed to have as few spaces as possible. When a lower bound on the sequence efficiency is preset, an operating point is preferably selected to be as close as possible to the lower bound. Correspondingly, when an upper bound on the maximum postfetching is preset, an operating point is selected to be as close as possible to the upper bound. One alternative method provides for selecting an operating point for which the slope of the function is approximately 45 degrees or −45 degrees. This operating point is selected because it yields a good compromise between the requirement for an excellent sequence efficiency or a low maximum postfetching, and the requirement for as few as possible spaces.

In FIG. 10, the horizontal line illustrates an upper bound of 75% on the sequence efficiency; the circle indicates an operating point having a slope of approximately 45 degrees. By specifying 75% for the upper bound, a number of at least 20 spaces is defined. It is preferably stipulated that the sorting buffer have precisely 20 spaces. The selection of an operating point having a slope of approximately 45 degrees leads to a number of 12 spaces and a resulting sequence efficiency of 60%. In FIG. 11, the horizontal line illustrates an upper bound on the maximum postfetching of 25 relative positions; the circle indicates an operating point having a slope of approximately 45 degrees. By stipulating the upper bound of 25 relative positions, a number of at least 16 spaces specified. It is preferably stipulated that the sorting buffer have precisely 16 spaces. By selecting an operating point having a slope of approximately 45 degrees, a number of eight spaces is obtained, and a maximum postfetching of 38 relative positions results.

In the specific embodiment described up to now, the sequence of reference orders and the sequence of reference production objects remain unchanged when used in the simulation. A variation of this procedure allows for the possibility that the reference type differs from the product type whose production is to be improved using the sorting buffer to be sized. This distinction is considered by altering the two reference sequences before a simulation is performed for each one of the possible values of spaces. At least one of the following modifications is made:
Using a random-number generator, individual reference orders and matching reference production objects are selected, and at least one feature that was produced in subprocess 100.2 and, therefore, belongs to the processing subset of the subprocess, is altered in both data records. For example, the reference type includes only vehicles for Europe and North America, whereas the product type also includes vehicles for Japan. In the reference type, the feature “license-plate recess in the rear opening hood” only has the characteristic “large license-plate recess”, whereas, in the product type, it has both possible characteristics, “large license-plate recess” and “small license-plate recess.” Individual reference orders and matching reference production objects are randomly selected and provided with the characteristic “small license-plate recess.”
Using a random-number generator, individual reference orders are selected, and at least one feature is altered in the data records of the selected reference orders. This feature belongs to the selection subset of subprocess 100.3. For example, the feature is the color of the top coat. The reference type has only 16 possible colors, thus characteristics of the feature “color of the top coat”, whereas the product type has 24 possible colors. A relative frequency of occurrence of each of these 24 possible colors is predefined. The characteristics of the feature “color of the top coat” in the data records of the reference type are modified in the data records of the reference type in such a way that the distribution of the top coat colors among the modified data records is approximately equal to the relative frequencies of occurrence.
The processing in subprocess 100.2 is improved in such a way that, already without the use of sorting buffers, the maximum prefetching and the maximum postfetching of the orders when delivering the same to subprocess 100.3 are better than in the case of the reference type. For example, when an order has already undergone a specific postfetching, a procedure is used in order to move up a production object matching the order and to deliver it to subprocess 100.3 without using sorting buffer 500.3. The effects of such measures are considered in the simulation in that the sequence of the reference production objects in the reference sequence is altered so that a predefined upper bound on the postfetching and the prefetching is observed, already without the use of sorting buffers. For example, if an upper bound on the postfetching and prefetching operations of five positions is predefined, and an order has already undergone a postfetching of five positions, then the order and a production object matching the order are selected in the simulation. As a result, the selected production object is moved up to the first position in the production-object sequence.

A further refinement of this method makes it possible to compare different ranges of variants under the given the product type. For example, two functions are generated: one for a range of variants of 16 different top coat colors, another for a range of variants of 24 different top coat colors. Two functions of the sequence quality are generated, and two functions of the maximum prefetching are generated, in each case as a function of the number of available spaces. Represented graphically, this shows a family of curves. Accordingly, it is possible to ascertain what effects an improvement in the positional quality in subprocess 100.2 will have on the sequence efficiency attained by sorting buffer 500.3. Two functions of the sequence efficiency and two functions of the maximum prefetching are generated, namely one in the case of an unchanged positional quality and one in the case of an improved positional quality.

### REFERENCE NUMERAL LIST

| Numerals | Signify |
|---|---|
| 10.1, 10.2, 10.3, . . . | orders of the copy of order sequence 60 |
| 11.1, 11.2, 11.3, . . . | orders of the original order sequence 50 |
| 20.1, 20.2, 20.3, . . . | production-object sequence following subprocess |
| | 100.2 |
| 50 | original order sequence |
| 60 | copy of the order sequence |
| 70 | production-object sequence |
| 100.1, 100.2, . . . | stations of the production process as subprocesses |
| 100.1 | lead-time logistics station |
| 100.2 | body-in-white station |
| 100.3 | surface finishing station |
| 100.4 | production logistics |
| 100.5 | interior assembly station |
| 100.6 | chassis and suspension station |
| 100.7 | breaking-in station |
| 100.8 | vehicle completion station |
| 110.1, 110.2 | work steps of subprocesses |
| 200.2 | selection point upstream of body-in-white station |
| 200.3 | selection point upstream of surface finishing |
| | station |
| 300 | order penetration point, selection |
| | point upstream of interior assembly station |
| 400.2 | electronic buffer memory for subprocess 100.2 |
| 400.3 | electronic buffer memory for subprocess 100.3 |
| 400.5 | electronic buffer memory for subprocess 100.5 |
| 500.3 | sorting buffer for production objects between |
| | subprocesses 100.2 and 100.3 |
| 500.5 | sorting buffer for production objects between |
| | subprocesses 100.3 and 100.5 |

1-29. (canceled)

30. A method for automatically controlling a production process for the series production of order-specific products, the production process including a first and a second subprocess, the method comprising:
generating a sequence of orders existing in electronic form for products that are manufactured in the production process;
manufacturing a sequence of production objects in the first subprocess in accordance with the order sequence;
carrying out a selection process, in which a production object of the production-object sequence and an order of the order sequence, which match one another, are selected;
manufacturing, from the selected production object in the second subprocess, a product in accordance with the selected order;
repeating the selection process and the product manufacturing until a product is manufactured for each order of the order sequence;
wherein
the production process includes a sorting buffer for production objects which has a fixed maximum number of available spaces for production objects; and
when a first order of the order sequence neither matches a production object in the sorting buffer nor the first production object of the production-object sequence, checking whether free spaces are available in the sorting buffer for all production objects residing in the production-object sequence upstream of a production object that matches the first order; and
when a sufficient number of free spaces is available, selecting the first order and the matching production object of the production-object sequence, and placing all production objects of the production-object sequence upstream of the selected production object in the sorting buffer.

31. The method as recited in claim 30 wherein:
each order includes features of the product to be manufactured in accordance with order-specific instructions;
each production object includes features which are manufactured in the first subprocess; and
in the test for determining whether a production object and an order match one another, the production-object features are compared to a subset of the product features.

32. The method as recited in claim 31 wherein a production object and an order are assessed as matching one another when every product feature of the order belonging to the subset is consistent with all of the features of the production object.

33. The method as recited in claim 31 wherein one feature that is drawn on for the comparison is the latest point in time by when the product is to be completed.

34. The method as recited in claim 31 wherein each product feature is provided with a weighting; when comparing a production object with an order using these weightings, a degree of correspondence is determined; and a production object and an order are then assessed as matching one another when the degree of correspondence reaches or exceeds a predefined bound.

35. The method as recited in claim 30 wherein, during the selection process, when the first order of the order sequence matches a production object in the sorting buffer, the order and the production object are selected, and the production object is removed from the sorting buffer.

36. The method as recited in claim 30 further comprising creating an initially empty electronic buffer memory for orders, and, when a first order of the order sequence neither matches a production object in the sorting buffer nor the first production object of the production-object sequence, and when there is an insufficient number of free spaces available in the sorting buffer, the first order is placed in the buffer memory.

37. The method as recited in claim 36 wherein, during the selection process, when an order in the buffer memory matches a production object in the sorting buffer, the order and production object are selected, and the order is removed from the buffer memory, and the production object from the sorting buffer; and, when every order in the buffer memory neither matches a production object in the sorting buffer nor the first production object of the production-object sequence, and when a sufficient number of free spaces is available in the sorting buffer, an order in the buffer memory and a production object matching the order, of the production-object sequence are selected, all production objects upstream of the selected production object are placed in the sorting buffer, and the order is removed from the buffer memory.

38. The method as recited in claim 37 wherein, when the number of selection processes during which a particular order remains in the buffer memory reaches or exceeds a predefined maximum number of selection processes, the particular order and a production object matching the particular order are selected from the production-object sequence, and the selected production object is moved up to the first position in the production-object sequence.

39. The method as recited in claim 30 further comprising creating an initially empty electronic buffer memory for orders; and when a first order of the order sequence neither matches a production object in the sorting buffer nor the first production object of the production-object sequence, the first order is placed in the buffer memory, and during the selection process, the orders in the buffer memory are first compared to production objects, and, when the number of selection processes during which a particular order remains in the buffer memory reaches or exceeds a predefined maximum number of selection processes, the particular order and a production object matching the particular order in the sorting buffer or the production-object sequence are selected, and the selected production object is moved up to the first position in the production-object sequence.

40. The method as recited in claim 30 wherein, in accordance with the order sequence, a sequence of order-specific subsystems are manufactured and used in the second subprocess for manufacturing the products; the production process includes a sorting buffer for subsystems; and a subsystem, which was manufactured on the basis of a deferred order, is placed, before being used, in a free space of the subsystem sorting buffer.

41. The method as recited in claim 40 wherein the subsystem sorting buffer has a fixed maximum number of available spaces, and further determining a quotient of the maximum number of available spaces of the subsystem sorting buffer and the number of order-specific subsystems used in the second subprocess for manufacturing an order-specific product, and,
when the number of orders in the buffer memory for production objects reaches or exceeds the quotient, the particular order and a production object matching the particular are selected from the production-object sequence, and the selected production object is moved up to a first position in the production-object sequence.

42. The method as recited in claim 30 wherein the sequence of orders in the order sequence prior to the first selection process is compared to the sequence in which the orders are selected, and for each order, a relative position in the selection sequence is determined in comparison to the position in the order sequence, a positional quality of the production process being computed from relative positions of all of the orders.

43. The method as recited in claim 42 wherein, when calculating the positional quality, a greatest value of all relative positions, a smallest value of all relative positions, and/or the average value of all relative positions are determined.

44. The method as recited in claim 30 wherein the sorting buffer includes a plurality of sorting sub-buffers for production objects; and before a production object is placed in the sorting buffer, a sorting sub-buffer is automatically selected, and the production object is placed in the sorting sub-buffer.

45. The method as recited in claim 44 wherein a current valuation is generated for each sorting sub-buffer with respect to a production object to be placed and is used for selecting the sorting sub-buffer; and the valuation is generated by computing one of the following individual valuations or by combining a plurality of the following individual valuations: the current total number of production objects in the sorting sub-buffer; the current number of those production objects in the sorting sub-buffer that were selected in a previous selection process, but were not yet removed from the sorting sub-buffer; the current total number of those production objects in the sorting sub-buffer, which differ in each case by at least one feature from the production object to be placed; and the expenditure of time required to place the production object to be placed, into the sorting sub-buffer.

46. The method as recited in claim 30 wherein a reference sequence of reference orders existing in electronic form is generated for reference products that are manufactured in the production process; a sequence of reference production objects is manufactured in the first subprocess in accordance with the reference order sequence; an electronic copy of the reference production-object sequence and an electronically available model of the sorting buffer are generated; various possible values are predefined for the maximum number of available spaces of the sorting buffer for production objects;
for each one of the predefined possible values: the maximum number of available spaces of the sorting buffer model is set to the value; a simulation is performed for all selection processes using the reference order sequence, the copy, the sorting buffer model and the buffer memory; and a reference production-object copy being able to be placed in the model when the model still has a free space;
one of the possible values being selected as a function of the results of the simulations; and a sorting buffer having the selected value as a maximum number of available spaces being used for the selection processes of the order sequence.

47. The method as recited in claim 46 wherein for each one of the predefined possible values for the maximum number the sequence of orders in the reference order sequence prior to the first selection process is compared to the sequence in which the reference orders are selected in the simulation for this value;
for each reference order, a relative position in the reference selection sequence is determined in comparison to the position in the order sequence; and, from the relative positions of all of the reference orders, a positional quality for this value being computed; and the value being selected as a function of the ascertained positional qualities.

48. The method as recited in claim 46 wherein an initially empty electronic buffer memory is created for reference orders; in a simulation, when the first reference order of the reference sequence does not match any reference production-object copy in the sorting buffer model, and when the model has an insufficient number of free spaces, the first reference order is placed in the buffer memory; and
for each of the predefined possible values, it is determined how many reference orders of the reference-order sequence were placed in the buffer memory over the course of the simulation for the predefined possible value;
a further value being selected, which leads in the simulation to a proportion of placed reference orders that is smaller than or equal to a predefined bound on the proportion;
and a sorting buffer having the further value as a maximum number of available spaces is used for the selection processes of the order sequence.

49. The method as recited in claim 46 wherein various possible, automatically evaluable procedures are specified for testing whether a production object and an order match one another or not; and for each of the predefined possible values and for each possible test procedure, the simulation of all selection processes is undertaken, in the simulation, the test procedure being used for comparing reference orders to reference production-object copies.

50. The method as recited in claim 49 wherein various possible subsets of product features are predefined; and, for each possible subset, the test procedure is generated and used as a possible test procedure which assesses a production object and an order as precisely matching one another when each product feature of the order which belongs to the possible subset is consistent with all of the features of the production object.

51. The method as recited in claim 46 wherein the sorting buffer includes a plurality of sorting sub-buffers for production objects; and the sorting buffer model includes a plurality of sorting sub-buffer models; before a production object is placed in the sorting buffer, a sorting sub-buffer is automatically selected, and the production object is placed in the same, a valuation function being used to generate a current valuation of each sorting sub-buffer; various possible valuation functions being predefined; a simulation of all selection processes including the selection of sorting sub-buffer models being performed for each possible valuation function using this valuation function; and one of the possible valuation functions being selected as a function of the simulation results.

52. The method as recited in claim 51 wherein, for each possible valuation function, a plurality of simulations is performed, over whose course at least one sorting sub-buffer model is deactivated at least temporarily.

53. The method as recited in claim 41 wherein various possible values are predefined for the maximum number of available spaces of the sorting buffer for subsystems; a reference sequence being generated of reference orders existing in electronic form, for reference products that are manufactured in the production process; a sequence of reference production objects being manufactured in the first subprocess in accordance with the reference order sequence; selection processes for reference orders and reference production objects are carried out as often as needed, until every reference order of the sequence has been selected; a maximum number of relative positions by which a reference order in the sequence, in which the reference orders are selected, lies behind the position of the reference order in the reference order sequence prior to the first selection process, is determined; the product of the maximum relative position and the number of order-specific subsystems which are used for manufacturing an order-specific product, being calculated;
and, as a sub-system sorting buffer, a sorting buffer is used, whose number of available spaces for subsystems is greater than or equal to the product.

54. A device for automatically controlling a production process for the series production of order-specific products, the production process including a first and a second subprocess, a sequence being provided of orders existing in electronic form, for products that are manufactured in the production process, a sequence of production objects being manufactured in the first subprocess in accordance with the order sequence, the device comprising:
means for implementing a selection process for selecting a production object of the production-object sequence and an order of the order sequence which match one another;
and from the selected production object in the second subprocess, a product being manufactured in accordance with the selected order;
a sorting buffer for production objects which has a fixed maximum number of available spaces for production objects;
means for checking whether a production object of the production-object sequence and an order of the order sequence match one another;
means for checking whether a production object in the sorting buffer and an order of the order sequence match one another;
means for checking whether free spaces are available in the sorting buffer for all production objects residing in the production-object sequence upstream of a production object that matches the first order; and
means for placing a production object of the production-object sequence in the sorting buffer.

55. The device as recited in claim 54 wherein the device includes an electronic buffer memory for orders; means for placing an order in the buffer memory; means for checking whether a production object of the production-object sequence and an order in the buffer memory match one another; and means for removing an order from the buffer memory.

56. The device as recited in claim 54 wherein the device includes a second sorting buffer for subsystems which are manufactured in accordance with the order sequence and are used in the second subprocess for manufacturing the products; and means for placing such a subsystem in the subsystem sorting buffer.

57. The device as recited in claim 54 wherein the sorting buffer includes a plurality of sorting sub-buffers for production objects; and the device includes means for automatically selecting a sorting sub-buffer, and means for placing a production object into a selected sorting sub-buffer.

58. The device as recited in claim 57 wherein the means for automatically selecting a sorting sub-buffer include means for generating a current valuation of each sorting sub-buffer with respect to a production object to be placed; and means for using the valuations for selecting a sorting sub-buffer.

59. A device for automatically controlling a production process for the series production of order-specific products, the production process including a first and a second subprocess, a sequence being provided of orders existing in electronic form, for products that are manufactured in the production process, a sequence of production objects being manufactured in the first subprocess in accordance with the order sequence, the device comprising:
a selector implementing a selection process for selecting a production object of the production-object sequence and an order of the order sequence which match one another;
and from the selected production object in the second subprocess, a product being manufactured in accordance with the selected order;
a sorting buffer for production objects which has a fixed maximum number of available spaces for production objects;
a comparator checking whether a production object of the production-object sequence and an order of the order sequence match one another;
a second comparator for checking whether a production object in the sorting buffer and an order of the order sequence match one another;
a free space determiner for checking whether free spaces are available in the sorting buffer for all production objects residing in the production-object sequence upstream of a production object that matches the first order; and
a placement device for placing a production object of the production-object sequence in the sorting buffer.
